(19) United States
(12) Patent Application Publication
(10) Pub. No.: US 2005/0012835 A1
(43) Pub. Date: Jan. 20, 2005

(54) Cathode ray tube and method for manufacturing the same

(76) Inventor: Nam Leen Leem, Gumi-si (KR)

Correspondence Address: BIRCH STEWART KOLASCH & BIRCH, PO BOX 747, FALLS CHURCH, VA, 22040-0747, US

(21) Appl. No.: 10/891,153

(22) Filed: Jul. 15, 2004

(30) Foreign Application Priority Data
Jul. 16, 2003 (KR) 10-2003-0048729

(51) Int. Cl. H04N 9/04

(52) U.S. Cl. 348/284

(57) ABSTRACT

The present invention discloses a cathode ray tube including an electron gun having a heater and a method for manufacturing the same. The heater is formed using a coil and includes a heat-emitting part having a heat-focusing part on which heat generated from the coil is focused and a buffering part for buffering shocks, and a triple coil part formed such that the coil is wound in three levels at predetermined pitches. The pitches of second and third levels of the triple coil part are substantially identical to each other and larger than the pitch of the first level. The present invention can improve the quality and welding reliability of the heater and reduce the quantity of coil required and time required for winding the coil while accomplishing high efficiency heating.

This Nonprovisional application claims priority under 35 U.S.C. § 119(a) on Patent Application No. 10-2003-0048729 filed in Korea on Jul. 16, 2003, the entire contents of which are hereby incorporated by reference.

### BACKGROUND OF THE INVENTION

1. Field of the Invention

The present invention relates to a cathode ray tube including an electron gun having a heater and a method for manufacturing the same. Specifically, the present invention relates to a cathode ray tube including an electron gun having a heater for applying heat to an oxide cathode to emit electrons and a method for manufacturing the same.

2. Description of the Background Art

FIG. 1 illustrates a conventional cathode ray tube. In general, the cathode ray tube includes a panel 110 on which a fluorescent material is coated, a shadow mask 120 combined with the inner side of the panel to select colors, a funnel 130 combined with the panel 110, a neck 150 in which an electron gun 140 is located, and a deflection yoke 160 for deflecting the cathode rays. The electron gun 140 includes a cathode 141 for emitting electrons built therein. The cathode 141 emits electrons according to voltage applied to a plurality of G1, G2 grids 143.

FIG. 2 illustrates the structure of a conventional oxide cathode.

As shown in FIG. 2, the oxide cathode using hot electron emission is generally used as the cathode 141. Referring to FIG. 2, the oxide cathode includes a hot electron emission layer 141-1, a gaseous metal 141-2, a heater 141-3, a sleeve 141-4, and an upholder 141-5. The chief ingredient of the hot electron emission layer 141-1 is alkaline earth metal carbonate such as BaCO₃, SrCO₃ and CaCO₃. The hot electron emission layer 141-1 is formed such that fine powder in the form of a needle having a longer side of approximately 8 μm and a shorter side of approximately 0.5 μm is coated using spray coating.

The gaseous metal 141-2 includes nickel as the chief ingredient and contains a minute quantity of reducing agent such as magnesium, silicon and tungsten. The gaseous metal 141-2 helps reduction of the hot electron emission layer 141-1 and upholds the hot electron emission layer 141-1.

The heater 141-3 is formed such that Al₂O₃ is coated on a thermal resistant wire as an insulating layer and generates heat. The sleeve 141-4 contains Ni-Cr as the chief ingredient and supports the gaseous metal 141-2. The sleeve 141-4 is generally blackened in order to effectively absorb heat from the heater 141-3 and transfer the absorbed heat to the gaseous metal 141-2. In general, a predetermined gap A is formed between the heater 141-3 and the sleeve 141-4 for electrical safety. The upholder 141-5 is made of an alloy having nickel as the chief ingredient and upholds the sleeve 141-4.

FIG. 3 illustrates the conventional heater 141-3 in detail. Referring to FIG. 3, the heater 141-3 includes a heat-emitting part B, a triple coil part C that applies power to the heat-emitting part B and serves as a lead wire for supporting the heater 141-3, and a weld part D welded to a heater support (not shown) for the purpose of supplying power. The heater 141-3 is inserted into the cathode 141 and welded. In addition, the heater 141-3 heats the hot electron emission layer 141-1 placed on the gaseous metal 141-2 such that the hot electron emission layer emits hot electrons.

The heater 141-3 is fabricated through processes of winding a bobbin, winding a single coil, baking, winding a double coil, forming, electro-depositing and coating, high-temperature sintering, dissolving a mandrel, neutralizing and cleaning, and drying.

FIG. 4 illustrates coil winding applied to the conventional heater. As shown in FIG. 4, the process of winding a single coil winds a coil 420 round a mandrel 410 at a predetermined pitch to continuously form the heat-emitting part B and the triple coil part C corresponding to a lead wire. Here, the mandrel 410 is formed using a molybdenum wire and the coil 420 is formed using a 3% rhenium-tungsten wire.

The triple coil part C is formed such that the coil is wound round the mandrel 410 by a predetermined length in the forward direction, by a predetermined length in the reverse direction, and then by a predetermined length in the forward direction again. When the triple coil part C is accomplished, the coil 420 is wound in the forward direction to form the heat-emitting part B. Here, the coil 420 is wound three times at the triple coil part C such that the triple coil part C supports the heater 141-3 and the wound triple coils come into contact with each other to become a conductor. Accordingly, the triple coil part C applies power to the heat-emitting part B.

Since the coil of the heat-emitting part B is wound once, the heat-emitting part B generates resistant heat caused by the intrinsic resistance of rhenium-tungsten forming the coil 420.

After the single coil winding process, the heater 141-3 is subjected to the baking process. The baking process removes particles on the surface of the coil 420 and facilitates the double coil winding process for forming the part B shown in FIG. 3. After the baking process, the heater 141-3 is formed into a predetermined size.

After the double coil winding and forming processes, the heater 141-3 is coated with an insulating material in order to prevent the generation of leakage current when the heater is inserted into the cathode. Al₂O₃ is generally used as the insulating material. In addition, a blackening layer is formed on the insulating material to effectively transfer radiant heat of the heater 141-3 to the cathode. The blackening layer is formed of Al₂O₃ and tungsten having a high radiation rate.

Then, the heater 141-3 is sintered. This is for the purpose of sintering Al₂O₃ to increase hardness. The sintering is carried out at a temperature of approximately 1600 to 1700° C. for 30 to 35 minutes in the ambient of dry hydrogen.

After the sintering process, the mandrel 410 is dissolved in a mixture of sulfuric acid and nitric acid. Then, the heater 141-3 passes through neutralization using liquid ammonia and cleaning and drying processes to be accomplished.

The resistance value of the accomplished heater at the normal temperature (23 to 27° C.) is the most importance item. That is, the resistance value of the heater is the most important factor of deciding the current value of the heater when the heater is inserted into the cathode and welded. The current value of the heater decides the temperature of the side of the cathode and is closely related to the expected life span of the cathode ray tube. In general, the temperature of the side of the cathode is directly proportional to the current value of the heater and the current value of the heater is inversely proportional to the resistance value of the heater at the normal temperature.

FIG. 5 illustrates coil winding applied to the conventional heater. In the conventional heater for the oxide cathode, the pitch a of the heat-emitting part B is smaller than the pitch b of the triple coil part C in the forward direction for high-efficiency heating, as shown in FIG. 5. The pitch c of the coil in the reverse direction is nine times the pitch b of the coil in the forward direction. Specifically, the pitch b in the forward direction is 641 μm and the pitch c in the reverse direction is 575 μm that is nine times 64 μm. The length of the coil 420 used for the triple coil part C is 296 mm and the entire coil length is 420 mm.

As described above, the coils of the heat-emitting part B and triple coil part C are tightly wound such that the length of the coil 420 constructing the heat-emitting part B becomes longer to increase the entire resistance of the heat-emitting part B. This obtains an additional heating value of approximately 30° C. at the rated voltage of the same condition.

However, the conventional heater has the following problems. Firstly, the coil 420 of the heat-emitting part B and triple coil part C is wound very tightly so that the coil has insufficient elasticity. Accordingly, the insulating layer of the heater is destroyed due to external shocks given to the heater and thermal expansion/contraction of the coil caused by power on/off. Furthermore, although the heat-emitting part B has a small coil pitch to accomplish the high-efficiency heater, the quantity of coil 420 required is increased to result in cost increase and productivity deterioration. Finally, the cross section of the coil has an oval shape, as shown in FIG. 5, because the first-level and third-level coils are wound in the same direction at the same pitch and the second-level coil is wound in the reverse direction at a large pitch. Thus, the heater is twisted when welded.

### SUMMARY OF THE INVENTION

Accordingly, an object of the present invention is to solve at least the problems and disadvantages of the background art.

An object of the present invention is to provide a cathode ray tube including an electron gun having a high efficiency heater, which can improve the quality and welding reliability of the heater and reduce the quantity of coil required and time required for winding the coil while accomplishing high efficiency heating.

To accomplish the above object, according to one aspect of the present invention, there is provided a cathode ray tube including an electron gun having a heater that is formed using a coil and includes a heat-emitting part having a heat-focusing part on which heat generated from the coil is focused and a buffering part for buffering shocks, and a triple coil part formed such that the coil is wound in three levels at predetermined pitches. The pitches of second and third levels of the triple coil part are substantially identical to each other and larger than the pitch of the first level.

According to another aspect of the present invention, there is also provided a method for manufacturing a cathode ray tube including an electron gun having a heater, comprising the steps of: winding a coil in one direction to form a heat-emitting part; winding the coil in one direction to form a first level; winding the coil in the direction opposite to the one direction at a pitch larger than the pitch of the first level to form a second level; and winding the coil in the one direction at the same pitch as the pitch of the second level to form a third level, whereby the first, second and third levels constitutes a triple coil part.

The present invention can improve the quality and welding reliability of the heater and reduce the quantity of coil required and time required for winding the coil while accomplishing high efficiency heating. Accordingly, manufacturing cost and time are minimized and reliability of the cathode ray tube is improved.

### BRIEF DESCRIPTION OF THE DRAWINGS

The invention will be described in detail with reference to the following drawings in which like numerals refer to like elements.

FIG. 1 illustrates a conventional cathode ray tube.

FIG. 2 illustrates the structure of a conventional oxide cathode.

FIG. 3 illustrates a conventional heater.

FIG. 4 illustrates coil winding applied to the conventional heater.

FIG. 5 illustrates coil winding applied to the conventional heater in detail.

FIG. 6 illustrates coil winding applied to a heater according to the present invention.

FIG. 7 is a graph showing comparison of heat generation efficiency of the heater according to the present invention to heat generation efficiency of the conventional heater.

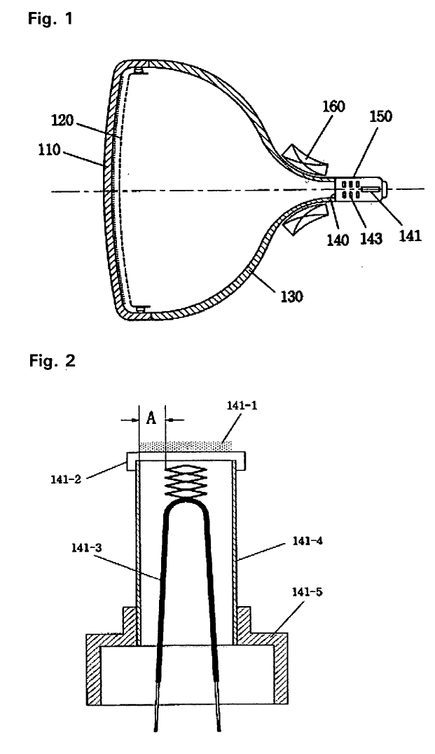

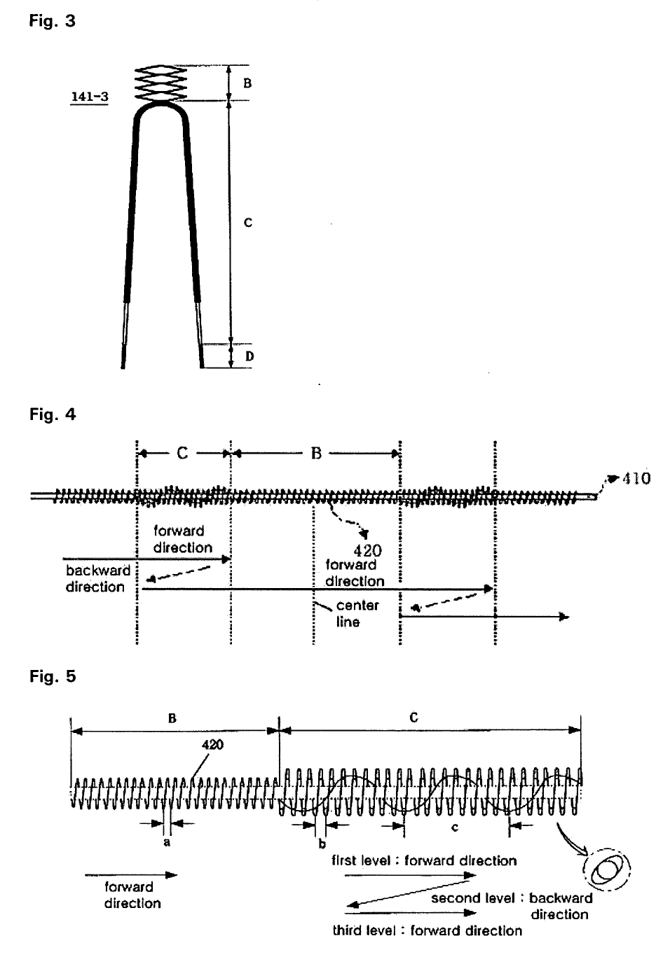

### DETAILED DESCRIPTION OF PREFERRED EMBODIMENTS

Preferred embodiments of the present invention will be described in a more detailed manner with reference to the drawings.

According to claim 1 of the present invention, there is provided a plasma display panel having a plurality of discharge cells, including barrier ribs by which a discharge space is defined between an upper substrate and a lower substrate; and an oxide film of a low dielectric constant formed on each of the barrier ribs.

According to claim 2 of the present invention, the oxide film of the plasma display panel as claimed in claim 1 comprises at least one of silicon oxide and magnesium oxide.

According to claim 3 of the present invention, the plasma display panel as claimed in claim 1 further comprises: a first electrode formed on the underside of the upper substrate; and a second electrode formed on the underside of the upper substrate in such a manner as to extend over the first electrode.

According to claim 4 of the present invention, the barrier ribs of The plasma display panel as claimed in claim 3 comprise: a first barrier rib arranged in parallel with the first and second electrodes and having an auxiliary discharge space; and a second barrier rib arranged to intersect the first barrier rib.

According to claim 5 of the present invention, there is also provided a method for manufacturing a plasma display panel, including the steps of: forming barrier ribs on a lower substrate so that a discharge space is defined by the barrier ribs between an upper substrate and a lower substrate; and forming an oxide film of a low dielectric constant on each of the barrier ribs.

According to claim 6 of the present invention, the oxide film of the method as claimed in claim 1 comprises at least one of silicon oxide and magnesium oxide.

According to claim 7 of the present invention, the method as claimed in claim 5 further comprises the steps of: forming a first electrode on the upper substrate; and forming a second electrode on the underside of the upper substrate in such a manner as to extend over the first electrode.

According to claim 8 of the present invention, the step of forming the barrier rib of the method as claimed in claim 7 comprises the step of: forming a first barrier rib arranged in parallel with the first and second electrodes and having an auxiliary discharge space and forming a second barrier rib that intersects the first barrier rib.

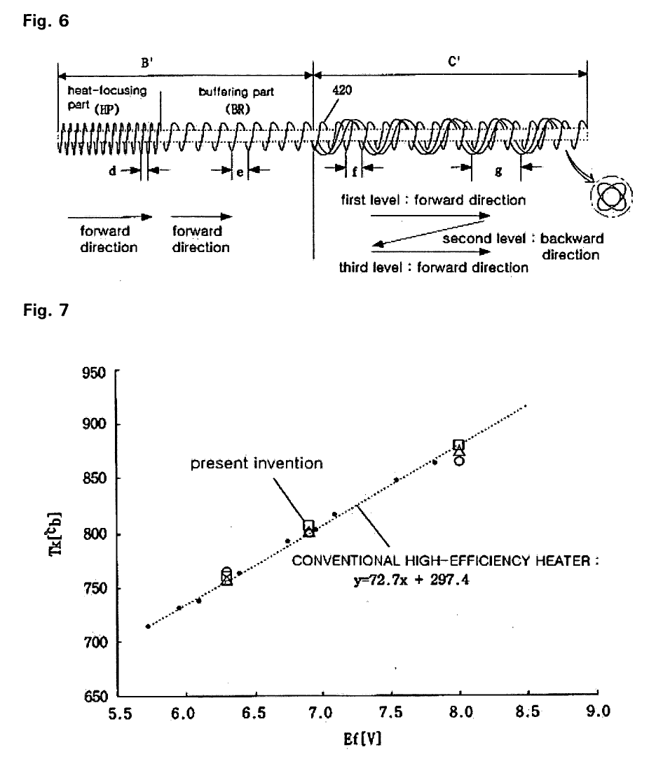

Hereinafter, preferred embodiments of the present invention will be described in a more detailed manner with reference to FIGS. 6 to 7.

FIG. 6 illustrates coil winding applied to a heater according to the present invention. Referring to FIG. 6, the heater according to the present invention includes a heat-emitting part B′ having a heat-focusing part HP and a buffering part BP, and a triple coil part C′.

The heat-focusing part HP converts power applied thereto into heat according to the intrinsic resistance of a coil 420 wound at a predetermined pitch d and transfers the heat to a cathode. Here, the pitch of the coil 420 forming the heat-focusing part HP is identical to the pitch of the coil forming the heat-emitting part B of the conventional heater. Accordingly, the heat-focusing part HP included in the heater of the present invention provides the same high thermal efficiency as that of the conventional heater.

The buffering part BP has a weak heating function compared to the heat-focusing part HP and has a coil wound in the same direction as the winding direction of the coil forming the heat-focusing part HP. Since the buffering part BP has a very low radiation rate for transferring heat to the cathode compared to the heat-focusing part HP, there is no need to reduce the pitch of the coil forming the buffering part BP in order to increase thermal efficiency. Accordingly, a speed of winding the coil forming the buffering part BP can be increased to make the pitch e of the coil constructing the buffering part BP larger than the pitch d of the coil forming the heat-focusing part HP. This can reduce the quantity of coil required and time required for winding the coil.

Furthermore, since the pitch e of the coil constructing the buffering part BP is larger than the pitch d of the coil constructing the heat-focusing part HP, the coil forming the buffering part has a predetermined degree of elasticity. Accordingly, deterioration in the reliability of the heater due to external shocks or thermal expansion/contraction of the coil can be prevented.

The number of times of winding the coil constructing the buffering part BP is at least 5% of the number of times of winding the coil constructing the heat-focusing part HP. In addition, the coil pitch e of the buffering part BP is twice larger than the coil pitch d of the heat-focusing part HP. When the coil pitch d of the heat-focusing part HP is 50 to 60 μm, the coil pitch e of the buffering part BP is 100 to 120 μm, which is larger than the coil pitch of the triple coil part of the conventional heater, 64 μm. It is the most preferable that the coil pitch of the buffering part BP is 110 μm.

The triple coil part C′ is formed such that the coil is wound in the same direction as the winding direction of the coil constructing the buffering part BP, wound in the reverse direction, and then wound in the same direction as the winding direction of the coil constructing the buffering part BP.

As described above, the triple coil part C′ is constructed such that the coil 420 is wound three times. The triple coil part C′ supports the heater 141-3 and the coils wound in three levels come into contact with each other to become a conductor state to apply power to the heat-emitting part B. Here, the pitch f of the first-level coil is 100 to 120 μm, which is identical to or larger than the pitch e of the coil constructing the buffering part BP, and the pitch g of the second-level and third-level coils is 300 to 360 μm. It is the most preferable that the pitch f of the first-level coil is 110 μm that is identical to the pitch e of the coil constructing the buffering part BP. This is because a heater manufacturing process becomes simplified when the coil constructing the buffering part BP and the first-level coil of the triple coil part C′ are continuously wound.

Furthermore, the pitch g of the second-level coil of the triple coil part C′ is three time the pitch f of the first-level coil. In addition, the pitch of the third-level coil is three times larger than the pitch f of the first-level coil. Accordingly, when the pitch f of the first-level coil is 110 μm, it is the most preferably that the pitch g of the second-level and third-level coils is 330 μm.

The pitches of the first-, second- and third-level coils of the triple coil part C′ of the present invention are respectively 110 μm, 330 μm and 330 μm while the pitches of the first-, second- and third-level coils of the triple coil part C of the conventional heater are respectively 64 μm, 576 μm and 64 μm. The length of the coil required for forming the triple coil part C′ of the present invention is 150 mm and time required for forming the triple coil part C′ is 7.5 seconds.

Accordingly, it can be known that, owing to a variation in the coil pitches of the triple coil part C′ of the present invention, the quantity of the coil required for the triple coil part C′ of the present invention and the time required for winding the coil are smaller than the quantity of the coil required for forming the conventional triple coil part C, 296 mm, and time required for forming the conventional triple coil part C, 13 seconds.

Furthermore, the second- and third-level coils of the triple coil part C′ of the present invention are wound in the directions opposite to each other at the same pitch and the first-level coil is wound in the forward direction at a small pitch. Thus, the cross section of the coil has an X shape, as shown in FIG. 6, so that the heater is not twisted when welded to improve welding reliability.

A method for manufacturing the heater included in the cathode ray tube according to the present invention will now be explained.

First, the coil is wound in one direction to form the heat-emitting part B′, that is, the heat-focusing part HP and buffering part BP. Here, the coil pitch e of the buffering part BP is twice larger than the coil pitch d of the heat-focusing part HP.

The coil is continuously wound in one direction to form the first level of the triple coil part C′, and then the coil is wound in the opposite direction to form the second level of the triple coil part C′ having the pitch g which is three times larger than the pitch f of the first level. Subsequently, the coil is wound in the one direction again to form the third level having the same pitch as the pitch g of the second level of the triple coil part C′.

FIG. 7 is a graph showing comparison of heat generation efficiency of the heater according to the present invention to heat generation efficiency of the conventional heater. In FIG. 7, the X-axis represents voltage applied to the heater and Y-axis represents the radiance temperature of the side of the cathode, which is increased by heat emitted from the heater.

Referring to FIG. 7, the heater of the present invention has thermal efficiency similar to that of the conventional heater. That is, the heater according to the present invention can obtain thermal efficiency similar to that of the conventional heater even when the heater of the present invention uses smaller quantity of coil required than the quantity of coil required for the conventional heater.

As described above, the present invention can improve the quality and welding reliability of the heater and reduce the quantity of coil required and time required for winding the coil while accomplishing high efficiency heating. Accordingly, manufacturing cost and time are minimized and reliability of the cathode ray tube is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A cathode ray tube including an electron gun having a heater, wherein
the heater is formed using a coil and includes a heat-emitting part having a heat-focusing part on which heat generated from the coil is focused and a buffering part for buffering shocks, and a triple coil part formed such that the coil is wound in three levels at predetermined pitches, the pitches of second and third levels of the triple coil part being substantially identical to each other and larger than the pitch of the first level.

2. The cathode ray tube as claimed in claim 1, wherein the pitch of the second-level coil of the triple coil part is three times larger than the pitch of the first-level coil of the triple coil part.

3. The cathode ray tube as claimed in claim 1, wherein the pitch of the coil forming the buffering part is identical to or smaller than that of the first-level coil of the triple coil part.

4. The cathode ray tube as claimed in claim 1, wherein the pitch of the coil forming the buffering part is identical to or larger than the pitch of the coil forming the heat-focusing part.

5. The cathode ray tube as claimed in claim 4, wherein the pitch of the coil forming the buffering part is twice larger than that of the coil forming the heat-focusing part.

6. A cathode ray tube including an electron gun having a heater, wherein
the heater is formed using a coil and includes a heat-emitting part having a heat-focusing part on which heat generated from the coil is focused and a buffering part for buffering shocks, and a triple coil part formed such that the coil is wound in three levels at predetermined pitches, the pitch of the coil forming the buffering part being identical to or smaller than that of the first-level coil of the triple coil part.

7. The cathode ray tube as claimed in claim 6, wherein the pitch of the second-level coil of the triple coil part is identical to that of the third-level coil of the triple coil part and larger than that of the first-level coil the triple coil part.

8. The cathode ray tube as claimed in claim 7, wherein the pitch of the second-level coil of the triple coil part is three times larger than that of the first-level coil of the triple coil part.

9. The cathode ray tube as claimed in claim 6, wherein the pitch of the coil forming the buffering part is identical to or larger than the pitch of the coil forming the heat-focusing part.

10. The cathode ray tube as claimed in claim 9, wherein the pitch of the coil forming the buffering part is twice larger than that of the coil forming the heat-focusing part.

11. A method for manufacturing a cathode ray tube including an electron gun having a heater, comprising the steps of:
winding a coil in one direction to form a heat-emitting part;
winding the coil in one direction to form a first level;
winding the coil in the direction opposite to the one direction at a pitch larger than the pitch of the first level to form a second level; and
winding the coil in the one direction at the same pitch as the pitch of the second level to form a third level,
whereby the first, second and third levels constitutes a triple coil part.

12. The method as claimed in claim 11, wherein the pitch of the second level of the triple coil part is three times larger than that of the first level of the triple coil part.
